(19) United States
(12) Patent Application Publication
(10) Pub. No.: US 2026/0253943 A1
(43) Pub. Date: Aug. 27, 2026

(54) ELECTRIC POWER STORAGE MODULE

(71) Applicant: KABUSHIKI KAISHA TOYOTA JIDOSHOKKI, Kariya-shi, Aichi (JP)

(72) Inventors: Yuki OKAMOTO, Kariya-shi (JP); Ryosuke KODAMA, Kariya-shi (JP)

(73) Assignee: KABUSHIKI KAISHA TOYOTA JIDOSHOKKI, Kariya-shi, Aichi (JP)

(21) Appl. No.: 18/725,945

(22) PCT Filed: Dec. 7, 2022
(86) PCT No.: PCT/JP2022/045162

§ 371 Date: Jul. 1, 2024

(30) Foreign Application Priority Data
Jan. 7, 2022 (JP) 2022-001467

(51) Int. Cl. H01M 10/0525; H01M 50/129; H01M 50/184; H01M 50/193

(52) U.S. Cl. CPC H01M 10/0525; H01M 50/129; H01M 50/184; H01M 50/193

(57) ABSTRACT

In an electric power storage module (1), a sheet member (30) including a metal layer is provided to cover an outer surface (10s) of a stacked body (10). Therefore, moisture intrusion into the stacked body (10) is curbed compared to a case in which a sheet configured only of a resin layer is provided. In particular, the sheet member (30) extends from a position on a current collector (15) of a positive terminal electrode (13) through an outer surface (10s) to a position on the current collector (15) of a negative terminal electrode (12), and is divided into a first portion (31) and a second portion (32) that partially overlap in a cross section along a stacking direction (D). A first portion (31) and a second portion (32) are electrically insulated from each other.

### TECHNICAL FIELD

The present disclosure relates to an electric power storage module.

### BACKGROUND ART

Patent Literature 1 describes an assembled battery. This assembled battery is made by stacking a plurality of sheet-shaped polymer secondary batteries (unit cells) and connecting each of the unit cells in series. This assembled battery includes a metal upper exterior plate that also serves as a positive electrode current collector, a metal lower exterior plate that also serves as a negative electrode current collector, and a metal intermediate exterior plate that also serves as a positive and negative electrode current collector. A rectangular frame-shaped resin sealing body is provided between the upper exterior plate and the intermediate exterior plate and between the lower exterior plate and the intermediate exterior plate, respectively. The sealing body is heat welded to each of the exterior plates. A power generation element is disposed in a space surrounded by each of the exterior plates and the sealing body. The power generation element is configured of a positive electrode layer, a negative electrode layer, and a gel type electrolyte layer interposed between the positive electrode layer and the negative electrode layer. The gel type electrolyte layer includes a non-aqueous electrolyte solution and a polymer that holds the electrolyte solution.

### CITATION LIST

### Patent Literature

[Patent Literature 1] Japanese Unexamined Patent Publication No. H11-233076

### SUMMARY OF INVENTION

### Technical Problem

However, in a non-aqueous secondary battery of which an electrolyte is a non-aqueous electrolyte, it is known that performance of the battery deteriorates due to moisture intrusion into the inside of the battery. Specifically, when moisture infiltrates into the battery, the quality of the electrolyte may change and resistance may increase, or an electrode active material or coating may decompose due to changed components, leading to a decrease in battery performance. Therefore, in the non-aqueous secondary battery, it is important to ensure airtightness of an exterior material of the battery in order to curb the intrusion of moisture such as atmospheric moisture. In the assembled battery described in Patent Literature 1, each of the power generation elements is sealed with a metal exterior plate and a resin frame-shaped sealing body. However, resins are known to be more permeable to moisture than metals. Sealing using a frame-shaped sealing body made of a resin may not be able to sufficiently curb moisture intrusion from the outside.

An object of the present disclosure is to provide an electric power storage module capable of curbing moisture intrusion while curbing short circuits.

### Solution to Problem

An electric power storage module according to the present disclosure includes a stacked body having an outer surface, and a sheet member provided in close contact with the stacked body to cover the outer surface in a cross section along a stacking direction of the stacked body, wherein the sheet member includes a metal layer, and a first insulating layer stacked on the metal layer and disposed closer to the outer surface than the metal layer, the stacked body includes a plurality of electrodes stacked along the stacking direction, a sealing part, and an electrolyte, each of the electrodes includes a current collector, the electrolyte is accommodated in a space between the current collectors adjacent to each other in the stacking direction, the sealing part is a frame-shaped member configured to seal the electrolyte in the space, the electrodes include a plurality of bipolar electrodes, a positive terminal electrode, and a negative terminal electrode, each of the bipolar electrodes includes the current collector, a positive electrode active material layer provided on one surface of the current collector, and a negative electrode active material layer provided on the other surface of the current collector, and is stacked such that the positive electrode active material layer and the negative electrode active material layer face each other, the positive terminal electrode includes the current collector and the positive electrode active material layer provided on the one surface of the current collector, and is stacked on the bipolar electrode at one end portion in the stacking direction of the stacked body, the negative terminal electrode includes the current collector and the negative electrode active material layer provided on the other surface of the current collector, and is stacked on the bipolar electrode at the other end portion in the stacking direction of the stacked body, the sealing part includes a plurality of frame-shaped first resin layers provided on a peripheral edge of each of the plurality of current collectors, and a second resin layer that seals the space by welding end portions of each of the plurality of first resin layers on a side opposite to the space, the outer surface includes an end surface of the second resin layer on the side opposite to the space, a first surface that is an outer surface in the stacking direction of the first resin layer provided on the current collector of the positive terminal electrode, and a second surface that is an outer surface in the stacking direction of the first resin layer provided on the current collector of the negative terminal electrode, the outer surface of the current collector in the stacking direction in each of the positive terminal electrode and the negative terminal electrode includes an exposed portion exposed to an outside from the sealing part, and the sheet member extends from the first surface to the second surface via the end surface, and is divided into a plurality of mutually insulated portions in the cross section along the stacking direction.

In the electric power storage module, the stacked body includes a plurality of bipolar electrodes, a positive terminal electrode, and a negative terminal electrode. In the stacked body, a frame-shaped sealing part for sealing an electrolyte is provided in a space between the current collectors of each of the electrodes. The sealing part includes a first resin layer provided on each of the current collectors, and a second resin layer that seals the space by welding outer end portions of the first resin layer to each other. The outer surface of the stacked body includes the first surface, the second surface, and the end surface. The first surface and the second surface are the outer surfaces in the stacking direction of the first resin layer provided on each of the positive terminal electrode and the negative terminal electrode. The end surface is an outer surface of the second resin layer. The sheet member including a metal layer is provided in close contact with the stacked body so as to cover the outer surface of the stacked body. Since the metal layer included in the sheet member has high barrier properties against moisture, moisture intrusion is curbed compared to the case of only a resin layer. In particular, the sheet member extends from the first surface to the second surface through the end surface, and is divided into a plurality of mutually insulated portions in the cross section along the stacking direction. Therefore, although the outer surfaces of the current collectors of the positive terminal electrode and the negative terminal electrode include the exposed portions exposed to the outside from the sealing part, short circuit between the positive terminal electrode and the negative terminal electrode is curbed via the sheet member. In this way, according to the electric power storage module, when moisture intrusion is curbed, short circuit can also be curbed.

In the electric power storage module according to the present disclosure, adjacent portions of the plurality of portions of the divided sheet member may include overlapping portions overlapping each other. In this case, the exposed portion of the sealing part from the sheet member is reduced by overlapping a plurality of portions of the sheet member, and thus intrusion of not only moisture but also air (nitrogen, oxygen, or the like) is curbed.

In the electric power storage module according to the present disclosure, adjacent portions of the plurality of portions of the divided sheet member may be spaced apart from each other such that a gap is formed between the end portions thereof, and an insulating member may be disposed in the gap. In this way, if the plurality of portions of the sheet member are spaced apart from each other, breakage of the metal layer due to deformation of the sheet member following expansion and contraction of the sealing part due to heat is reliably curbed. Furthermore, gas generated inside the sheet member escapes from the gap, and thus an increase in internal pressure is curbed.

In the electric power storage module according to the present disclosure, the sealing part may include a plurality of frame-shaped third resin layers, the third resin layer may be disposed to be interposed between the first resin layers adjacent to each other in the stacking direction, and the second resin layer may seal the space by welding end portions of each of the plurality of first resin layers and the plurality of third resin layers on a side opposite to the space. In this case, a plurality of spaces can be sealed all at once by the second resin layer integrally formed in the stacking direction, and manufacturing thereof is easy.

In the electric power storage module according to the present disclosure, the sheet member may include a second insulating layer stacked on the metal layer on a side opposite to the first insulating layer, and in the overlapping portion, electrical insulation may be formed by overlapping the first insulating layer of one of the portions and the second insulating layer of the other one of the portions adjacent to the one of the portions. In this case, since the metal layer is interposed between two insulating layers, insulation can be easily ensured by overlapping each of the portions of the sheet member.

In the electric power storage module according to the present disclosure, in the overlapping portion, one of the portions located relatively vertically upward may overlap on the other one of the portions located relatively vertically downward. In this case, at the overlapping portion of each of the portions of the sheet member, storage of water flowing from vertically upward to vertically downward is curbed.

The electric power storage module according to the present disclosure may further include an insulating tape attached to the sheet member to cover the overlapping portion. In this case, peeling at the overlapping portion at the overlapping portion of each of the portions of the sheet member can be prevented, and moisture intrusion can be reliably curbed.

In the electric power storage module according to the present disclosure, the plurality of portions may include a first portion which extends from the first surface to the end surface, and a second portion which extends from the second surface to the end surface, and the first portion and the second portion may overlap each other on the end surface.

In the electric power storage module according to the present disclosure, the plurality of portions may include a first portion disposed on the first surface, a second portion disposed on the second surface, and a third portion which extends from the end surface to overlap each of the first portion and the second portion, and at the overlapping portion between each of the first portion and the second portion, and the third portion, the third portion may overlap on the outside of the first portion and the second portion.

In the electric power storage module according to the present disclosure, the plurality of portions may include a first portion disposed on the first surface, a second portion disposed on the second surface, and a third portion which extends from the end surface to overlap each of the first portion and the second portion, at the overlapping portion between the first portion and the third portion, in the cross section along the stacking direction, an end portion of the first portion and an end portion of the third portion may be in contact with each other such that the end portion of the third portion is closer to the stacked body than the end portion of the first portion, and at the overlapping portion of the second portion and the third portion, in the cross section along the stacking direction, an end portion of the second portion and an end portion of the third portion may be in contact with each other such that the end portion of the third portion is closer to the stacked body than the end portion of the second portion.

Further, in the electric power storage module according to the present disclosure, the plurality of portions may include a first portion which extends from one of the first surface and the second surface to cover the end surface, and a second portion which extends from the other one of the first surface and the second surface toward the first portion. In this way, in order to curb moisture intrusion while curbing short circuits, various aspects of dividing the sheet member can be considered.

In the electric power storage module according to the present disclosure, the current collector may include a first region in which the positive electrode active material layer and the negative electrode active material layer are formed when seen in the stacking direction, a second region located outside the first region when seen in the stacking direction, and a third region located outside the second region when seen in the stacking direction and in which the first resin layer is formed, and the sheet member may extend to reach near a boundary between the third region and the second region when seen in the stacking direction. In this case, the sheet member is disposed on the first resin layer so that an end portion thereof does not reach the second region. By covering a wide region of the sealing part with the sheet member, it is possible to curb short circuit between the positive terminal electrode and the negative terminal electrode, and to more effectively curb moisture intrusion into the inside of the stacked body.

In the electric power storage module according to the present disclosure, the stacked body may have a rectangular shape having four side portions when seen in the stacking direction, and the sheet member may be provided along at least one of the four side portions when seen in the stacking direction. In this way, it is sufficient that the sheet member is provided on at least one side portion of the stacked body when seen in the stacking direction.

In the electric power storage module according to the present disclosure, the sheet member may be divided into a plurality of fourth portions when seen in the stacking direction, and when seen in the stacking direction, end portions of the adjacent fourth portions may overlap each other to form an overlapping portion. In this case, in a configuration in which the sheet member is divided into a plurality of portions when seen in the stacking direction, formation of a conductive path due to dew condensation water entering between the portions is curbed.

### Advantageous Effects of Invention

According to the present disclosure, it is possible to provide an electric power storage module capable of curbing moisture intrusion while curbing short circuits.

### BRIEF DESCRIPTION OF DRAWINGS

FIG. 1 is a schematic cross-sectional view of an electric power storage module according to an embodiment.

FIG. 2 is an enlarged cross-sectional view of a region AR in FIG. 1.

FIG. 3 is a cross-sectional view showing a part of the electric power storage module shown in FIG. 1.

FIG. 4 is a schematic plan view of the electric power storage module shown in FIG. 1.

FIG. 5 is a schematic cross-sectional view of an electric power storage module according to a first modified example.

FIG. 6 is a schematic cross-sectional view of an electric power storage module according to a second modified example.

FIG. 7 is a schematic cross-sectional view of an electric power storage module according to a third modified example.

FIG. 8 is a schematic cross-sectional view of an electric power storage module according to a fourth modified example.

FIG. 9 is a schematic cross-sectional view of an electric power storage module according to a fifth modified example.

### DESCRIPTION OF EMBODIMENTS

Hereinafter, one embodiment of the present disclosure will be described in detail with reference to the accompanying drawings. In addition, in the description of the drawings, the same or equivalent elements may be designated by the same reference numerals, and redundant description may be omitted.

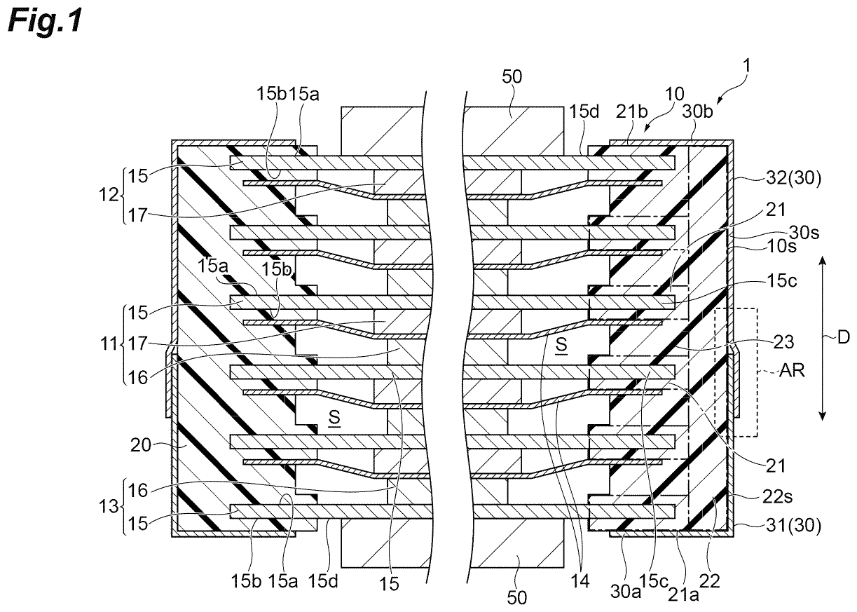

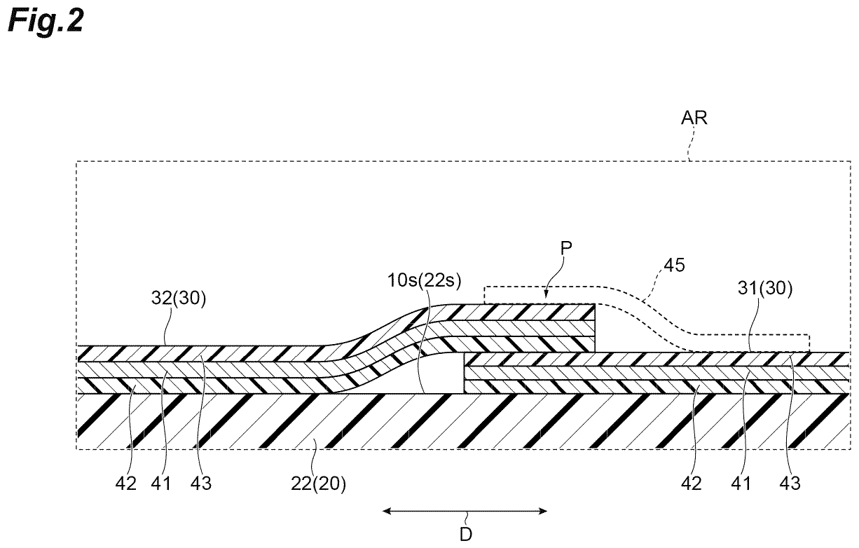

FIG. 1 is a schematic cross-sectional view of an electric power storage module according to an embodiment. FIG. 2 is an enlarged cross-sectional view of a region AR in FIG. 1. The electric power storage module 1 shown in FIGS. 1 and 2 is, for example, an electric power storage module used in batteries of various vehicles such as forklifts, hybrid vehicles, and electric vehicles. The electric power storage module 1 is, for example, a secondary battery such as a nickel-hydride secondary battery or a lithium ion secondary battery. The electric power storage module 1 may be an electric double layer capacitor or an all-solid-state battery. Here, a case in which the electric power storage module 1 is a lithium ion secondary battery will be exemplified.

The electric power storage module 1 includes a stacked body 10 and a sheet member 30. The stacked body 10 includes a plurality of electrodes, a plurality of separators 14, a sealing part 20, and an electrolyte (not shown). The plurality of electrodes include a plurality of bipolar electrodes 11, a negative terminal electrode 12, and a positive terminal electrode 13.

Each of the plurality of bipolar electrodes 11 includes a current collector 15, a positive electrode active material layer 16, and a negative electrode active material layer 17. The current collector 15 has a rectangular sheet shape, for example. The positive electrode active material layer 16 is provided on one surface 15a of the current collector 15. The negative electrode active material layer 17 is provided on the other surface 15b of the current collector 15. The plurality of bipolar electrodes 11 are stacked such that the positive electrode active material layer 16 of one bipolar electrode 11 and the negative electrode active material layer 17 of another bipolar electrode 11 face each other. Here, a direction in which the bipolar electrodes 11 are stacked is referred to as a stacking direction D. The one surface 15a of the current collector 15 is a surface that faces one side in the stacking direction D, and the other surface 15b of the current collector 15 is a surface that faces the other side in the stacking direction D.

The positive electrode active material layer 16 and the negative electrode active material layer 17 have a rectangular shape when seen in the stacking direction D. The negative electrode active material layer 17 is one size larger than the positive electrode active material layer 16 when seen in the stacking direction D. That is, in a plan view seen in the stacking direction D, an entire formation region of the positive electrode active material layer 16 is located within a formation region of the negative electrode active material layer 17.

The negative terminal electrode 12 includes the current collector 15 and the negative electrode active material layer 17 provided on the other surface 15b of the current collector 15. The negative terminal electrode 12 does not include the positive electrode active material layer 16 and the negative electrode active material layer 17 on one surface 15a of the current collector 15. That is, no electrode active material layer is provided on the one surface 15a of the current collector 15 of the negative terminal electrode 12. The negative terminal electrode 12 is stacked on the bipolar electrode 11 at one end portion of the stacked body 10 in the stacking direction D. The negative terminal electrode 12 is stacked on the bipolar electrode 11 such that the negative electrode active material layer 17 thereof faces the positive electrode active material layer 16 of the bipolar electrode 11. Therefore, the one surface 15a of the current collector 15 of the negative terminal electrode 12 faces the outside of the stacked body 10, and a part thereof is exposed to the outside of the stacked body 10.

The positive terminal electrode 13 includes the current collector 15 and the positive electrode active material layer 16 provided on the one surface 15a of the current collector 15. The positive terminal electrode 13 does not include the positive electrode active material layer 16 and the negative electrode active material layer 17 on the other surface 15b of the current collector 15. In other words, no electrode active material layer is provided on the other surface 15b of the current collector 15 of the positive terminal electrode 13. The positive terminal electrode 13 is stacked on the bipolar electrode 11 at the other end portion of the stacked body 10 in the stacking direction D. The positive terminal electrode 13 is stacked on the bipolar electrode 11 such that the positive electrode active material layer 16 thereof faces the negative electrode active material layer 17 of the bipolar electrode 11. Therefore, the other surface 15b of the current collector 15 of the positive terminal electrode 13 faces the outside of the stacked body 10, and a part thereof is exposed to the outside of the stacked body 10.

The separator 14 is disposed between adjacent bipolar electrodes 11, between the negative terminal electrode 12 and the bipolar electrode 11, and between the positive terminal electrode 13 and the bipolar electrode 11. The separator 14 is interposed between the positive electrode active material layer 16 and the negative electrode active material layer 17. The separator 14 separates the positive electrode active material layer 16 and the negative electrode active material layer 17 to prevent short circuits caused by contact between adjacent electrodes. The separator 14 allows charge carriers such as lithium ions to pass through.

The current collector 15 is a chemically inert electrical conductor that allows a current to continue flowing through the positive electrode active material layer 16 and the negative electrode active material layer 17 during discharging or charging of the lithium ion secondary battery. A material of the current collector 15 is, for example, a metal material, a conductive resin material, a conductive inorganic material, or the like. Examples of the conductive resin material include resins in which a conductive filler is added to a conductive polymer material or a non-conductive polymer material as necessary. The current collector 15 may include a plurality of layers. In this case, each of the layers of the current collector 15 may contain the above metal material or conductive resin material.

A coating layer may be formed on a surface of the current collector 15. The coating layer may be formed by a known method such as plating or spray coating. The current collector 15 may have, for example, a plate shape, a foil shape (for example, a metal foil), a film shape, a mesh shape, or the like. Examples of the metal foil include an aluminum foil, a copper foil, a nickel foil, a titanium foil, and a stainless steel foil. Examples of the stainless steel foil include SUS 304, SUS 316, SUS 301, or the like defined in JIS G 4305:2015. When the stainless steel foil is used as the current collector 15, mechanical strength of the current collector 15 can be ensured. The current collector 15 may be an alloy foil or clad foil of the above metal. When the current collector 15 has a foil shape, a thickness of the current collector 15 may be, for example, 1 μm to 100 μm.

The positive electrode active material layer 16 includes a positive electrode active material that can occlude and release charge carriers such as lithium ions. Examples of the positive electrode active material include lithium composite metal oxides having a layered rock salt structure, metal oxides having a spinel structure, and polyanionic compounds. The positive electrode active material may be any material that can be used in lithium ion secondary batteries. The positive electrode active material layer 16 may include a plurality of positive electrode active materials. In this embodiment, the positive electrode active material layer 16 contains olivine-type lithium iron phosphate (LiFePO₄) as a composite oxide.

The negative electrode active material layer 17 includes a negative electrode active material that can occlude and release charge carriers such as lithium ions. The negative electrode active material may be any one of a single substance, an alloy, and a compound. Examples of the negative electrode active material include Li, carbon, metal compounds, and the like. The negative electrode active material may be an element that can be alloyed with lithium, a compound thereof, or the like. Examples of carbon include natural graphite, artificial graphite, hard carbon (hardly graphitizable carbon), and soft carbon (easily graphitizable carbon). Examples of the artificial graphite include highly oriented graphite, mesocarbon microbeads, and the like. Examples of elements that can be alloyed with lithium include silicon, tin, and the like. In this embodiment, the negative electrode active material layer 17 contains graphite as a carbon-based material.

Each of the positive electrode active material layer 16 and the negative electrode active material layer 17 (hereinafter, it may be simply referred to as “electrode active material layer”) may further include a conductive assistant, a binder, an electrolyte (a polymer matrix, an ionically conductive polymer, an electrolyte solution, or the like), an electrolyte supporting salt (lithium salt) to increase ionic conductivity, and the like for increasing electrical conductivity, if necessary. The conductive assistant is added to enhance conductivity of each of the electrodes (the bipolar electrode 11, the negative terminal electrode 12, the positive terminal electrode 13). Examples of the conductive assistant include acetylene black, carbon black, graphite, and the like.

Examples of the binder include polyvinylidene fluoride, polytetrafluoroethylene, fluororesins such as fluororubber, thermoplastic resins such as polypropylene and polyethylene, imide-based resins such as polyimide and polyamideimide, alkoxysilyl group-containing resins, acrylic resins such as acrylic acid or methacrylic acid, styrene-butadiene rubber (SBR), carboxymethyl cellulose, alginates such as sodium alginate and ammonium alginate, water-soluble crosslinked cellulose esters, starch-acrylic acid graft polymers, and the like. The binders may be used alone or in combination. As a solvent, for example, water, N-methyl-2-pyrrolidone (NMP), or the like are used.

The separator 14 may be, for example, a porous sheet or nonwoven fabric containing a polymer that absorbs and holds an electrolyte. Examples of the material for the separator 14 include polypropylene, polyethylene, polyolefin, polyester, and the like. The separator 14 may have a single layer structure or a multilayer structure. The multilayer structure may have, for example, a ceramic layer as an adhesive layer or a heat-resistant layer. The separator 14 may be impregnated with an electrolyte. The separator 14 may be made of an electrolyte such as a polymer electrolyte or an inorganic electrolyte. The electrolyte impregnated into the separator 14 may include, for example, a liquid electrolyte (an electrolyte solution) containing a non-aqueous solvent and an electrolyte salt dissolved in the non-aqueous solvent, or a polymer gel electrolyte containing an electrolyte held in a polymer matrix.

When the separator 14 is impregnated with an electrolytic solution, known lithium salts such as LiClO₄, LiAsF₆, LiPF₆, LiBF₄, LiCF₃SO₃, LiN(FSO₂)₂, and LiN(CF₃SO₂)₂ may be used as the electrolyte salt. Further, as the non-aqueous solvent, known solvents such as cyclic carbonates, cyclic esters, chain carbonates, chain esters, and ethers may be used. Two or more of the known solvent materials may be used in combination.

The sealing part 20 is formed in a frame shape at a peripheral edge portion of the stacked body 10 to surround the stacked body 10. The sealing part 20 can be joined to each of the one surface 15a and the other surface 15b of each of the current collectors 15 at a peripheral edge portion 15c of each of the current collectors 15. The sealing part 20 seals each of spaces S between adjacent current collectors 15 in the stacking direction D. Each of the spaces S accommodates an electrolyte. When the electrolyte is liquid, the sealing part 20 prevents the electrolyte from permeating to the outside. The sealing part 20 curbs moisture and the like entering the space S from the outside of the stacked body 10. The sealing part 20 prevents, for example, gas generated at each of the electrodes due to a charging and discharging reaction or the like from leaking to the outside of the electric power storage module 1. An edge portion of each of the separators 14 is joined to the sealing part 20. The sealing part 20 includes an insulating material. Examples of the material of the sealing part 20 include various resin materials such as polypropylene, polyethylene, polystyrene, ABS resins, acid-modified polypropylene, acid-modified polyethylene, and acrylonitrile styrene resins.

The sealing part 20 includes a plurality of first resin layers 21, a second resin layer 22, and a plurality of third resin layers 23. The first resin layer 21 is provided on each of the current collectors 15. Therefore, the plurality of first resin layers 21 are stacked on each other in the stacking direction D. The first resin layer 21 has a frame shape. The first resin layer 21 is provided on the peripheral edge portion 15c of the current collector 15. That is, the first resin layer 21 is provided from the one surface 15a of the current collector 15 to the other surface 15b via an end surface, and covers the peripheral edge portion 15c. The first resin layer 21 may be welded to at least one of the one surface 15a and the other surface 15b of the current collector 15.

Each of the plurality of third resin layers 23 is disposed to be interposed between the adjacent first resin layers 21 in the stacking direction D. Thus, the plurality of third resin layers 23 hold a space between adjacent first resin layers 21, that is, between adjacent current collectors 15. The third resin layer 23 has a frame shape. The third resin layer 23 is disposed on the peripheral edge portion 15c of the current collector 15 when seen in the stacking direction D. The third resin layer 23 may be welded to at least one of a pair of first resin layers 21 adjacent to each other in the stacking direction D. Here, an end portion of the separator 14 is sandwiched and fixed between the first resin layer 21 and the third resin layer 23.

The second resin layer 22 is an end surface welding layer formed by welding and integrating portions of the plurality of first resin layers 21 and the plurality of third resin layers 23 that overlap in the stacking direction D. The second resin layer 22 has a frame shape surrounding the stacked body 10 when seen in the stacking direction D. In the second resin layer 22, end portions of the plurality of first resin layers 21 and end portions of the plurality of third resin layers 23 adjacent to each other are welded and integrated. Thus, the space S formed between adjacent electrodes with the separator 14 interposed therebetween is sealed. An end surface 22s of the second resin layer 22 on the side opposite to the space S constitutes a part of an outer surface 10s of the stacked body 10.

That is, the outer surface 10s of the stacked body 10 includes the above-described end surface 22s, a first surface 21a, and a second surface 21b. The first surface 21a is an outer surface in the stacking direction D of the first resin layer 21 provided on the current collector 15 of the positive terminal electrode 13. The second surface 21b is an outer surface in the stacking direction D of the first resin layer 21 provided on the current collector 15 of the negative terminal electrode 12. That is, the outer surface 10s of the stacked body 10 is an outer surface of the sealing part 20.

The one surface 15a of the negative terminal electrode 12 that faces the outside of the stacked body 10 includes an exposed portion 15d exposed to the outside from the sealing part 20 (the first resin layer 21). The exposed portion 15d of the negative termination electrode 12 is a portion of the current collector 15 of the negative termination electrode 12 other than the second surface 21b (a portion that does not overlap the second surface 21b) when seen in the stacking direction D. Further, the other surface 15b of the positive terminal electrode 13 that faces the outside of the stacked body 10 includes an exposed portion 15d exposed to the outside from the sealing part 20 (the first resin layer 21). The exposed portion 15d of the positive terminal electrode 13 is a portion of the current collector 15 of the positive terminal electrode 13 other than the first surface 21a (a portion that does not overlap the first surface 21a) when seen in the stacking direction D. The exposed portions 15d provided at the negative terminal electrode 12 and the positive terminal electrode 13 function as terminals for extracting current from the electric power storage module 1. In the electric power storage module 1, a conductive member 50 is disposed on the exposed portions 15d and electrically connected. The conductive member 50 is used to electrically connect a plurality of electric power storage modules 1. Furthermore, the conductive member 50 can also be used as a restriction member to apply a restriction load to the stacked body 10.

A cooling channel may be formed in the conductive member 50. The stacked body 10 can be cooled by flowing a cooling medium through the cooling channel formed in the conductive member 50. In other words, coolers are disposed at both end portions of the stacked body 10 in the stacking direction D with respect to the exposed portion 15d of the outer surface of the current collector 15. In this case, dew condensation water is more likely to generate around the conductive member 50 at both end portions of the stacked body 10 in the stacking direction D compared to other portions.

The sheet member 30 is disposed in close contact with the stacked body 10 to cover the outer surface 10s of the stacked body 10. The sheet member 30 includes at least a metal layer 41 and a first insulating layer 42 stacked on the metal layer 41. In this embodiment, the sheet member 30 further includes a second insulating layer 43 stacked on the metal layer 41 on the side opposite to the first insulating layer 42. The second insulating layer 43 is provided on the other surface of the metal layer 41 opposite to one surface on which the first insulating layer 42 is provided. That is, the sheet member 30 is configured by sandwiching the metal layer 41 between the first insulating layer 42 and the second insulating layer 43. The sheet member 30 is provided on the stacked body 10 so that the first insulating layer 42 is on the outer surface 10s side of the stacked body 10. Here, the first insulating layer 42 is in contact with the outer surface 10s. In the sheet member 30, the first insulating layer 42 may function as an adhesive layer to the outer surface 10s. Alternatively, another adhesive layer may be interposed between the sheet member 30 and the outer surface 10s.

The first insulating layer 42 is made of a resin having insulating properties. A material of the first insulating layer 42 is, for example, polypropylene, polyethylene, polyamide, or the like. The material of the first insulating layer 42 may be selected from the same materials as the sealing part 20 from the viewpoint of adhesiveness with the sealing part 20. The metal layer 41 is made of a material with low moisture permeability (a low moisture permeability coefficient), such as an aluminum foil or a stainless steel foil. The second insulating layer 43 is made of, for example, a resin having insulating properties. The material of the second insulating layer 43 is, for example, polypropylene, polyethylene, polyamide, nylon, or the like. As an example, the sheet member 30 is an aluminum laminate sheet, and polypropylene may be selected as the first insulating layer 42, aluminum may be selected as the metal layer 41, and polyethylene terephthalate may be selected as the second insulating layer 43.

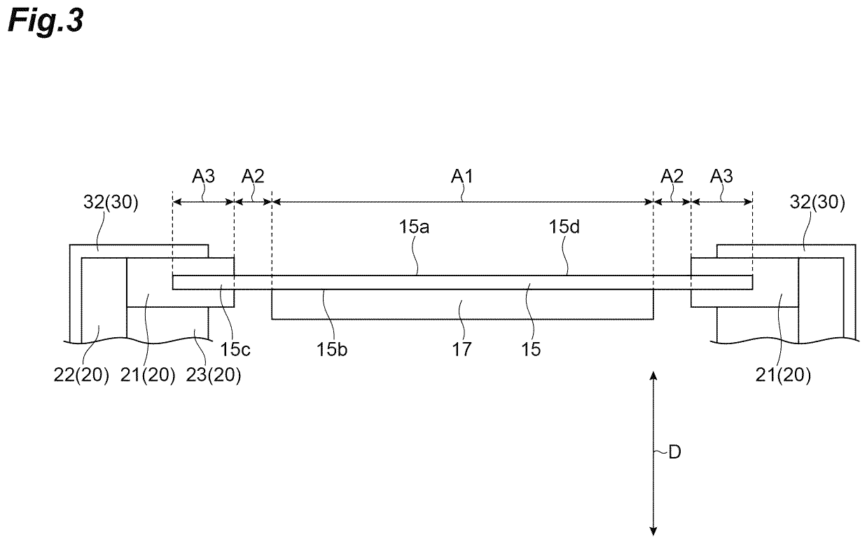

The sheet member 30 includes a portion 30a located on the first surface 21a on the positive terminal electrode 13 side, a portion 30s located on the end surface 22s, and a portion 30b located on the second surface 21b on the negative terminal electrode 12 side. Thus, the sheet member 30 extends from the first surface 21a to the second surface 21b via the end surface 22s. As shown in FIG. 3, the current collector 15 of the negative terminal electrode 12 includes a first region A1, a second region A2, and a third region A3. The first region A1 is a region in which the negative electrode active material layer 17 is formed when seen in the stacking direction D. The second region A2 is located outside the first region A1 when seen in the stacking direction D, and is a region in which the negative electrode active material layer 17 is not formed. The third region A3 is located outside the second region A2 when seen in the stacking direction D, and is a region in which the first resin layer 21 is formed. Similarly, the current collector 15 of the positive terminal electrode 13 includes a first region A1, a second region A2, and a third region A3. The first region A1 is a region in which the positive electrode active material layer 16 is formed when seen in the stacking direction D. The second region A2 is located outside the first region A1 when seen in the stacking direction D, and is a region in which the positive electrode active material layer 16 is not formed. The third region A3 is located outside the second region A2 when seen in the stacking direction D, and is a region in which the first resin layer 21 is formed. As an example, the sheet member 30 extends to cover the third region A3 of the current collector 15 and to reach near a boundary between the third region A3 and the second region A2 when seen in the stacking direction D.

On the other hand, the sheet member 30 may be terminated so as not to reach the exposed portion 15d including the first region A1 and the second region A2. In this case, an end portion of the sheet member 30 may be placed in the third region A3. Here, the end portion of the sheet member 30 is aligned with an inner edge of the third resin layer 23 when seen in the stacking direction D, but the end portion is not limited thereto and may be located in the third region A3. FIG. 3 is a cross-sectional view showing a part of the electric power storage module 1 shown in FIG. 1, but hatching is omitted.

As shown in FIGS. 1 and 2, the sheet member 30 is divided into a plurality of portions in a cross section (any cross section including the shown cross section) in the stacking direction D such that, at least, the metal layer 41 in the portion 30a on the positive terminal electrode 13 side and the metal layer 41 in the portion 30b on the negative terminal electrode 12 side are electrically insulated. In this embodiment, the sheet member 30 is divided into a first portion 31 extending from the first surface 21a to the end surface 22s, and a second portion 32 extending from the second surface 21b to the end surface 22s in a cross section along the stacking direction D. The first portion 31 and the second portion 32 overlap each other on the end surface 22s. Thus, the end surface 22s is covered with the sheet member 30. That is, here, the sheet member 30 is divided into the first portion 31 and the second portion 32 that are insulated from each other in a cross section along the stacking direction D. Further, the first portion 31 and the second portion 32 have an overlapping portion P in which they overlap each other. At the overlapping portion P between the first portion 31 and the second portion 32, the first insulating layer 42 of the second portion 32 is brought into contact with the second insulating layer 43 of the first portion 31. In the shown example, at the overlapping portion P, an end portion of the second portion 32 overlaps the outside (the side opposite to the stacked body 10) of an end portion of the first portion 31.

In this way, in the sheet member 30, the first portion 31 and the second portion 32 are electrically insulated. That is, the sheet member 30 is electrically isolated in the middle. Therefore, the exposed portion 15d of the positive terminal electrode 13 and the exposed portion 15d of the negative terminal electrode 12 are prevented from being short-circuited via the metal layer 41 of the sheet member 30. For example, as described above, even if dew condensation water is generated around the conductive member 50 (the cooler) and the dew condensation water forms a conductive path between the exposed portion 15d of the current collector 15 and the metal layer 41 of the sheet member 30 adjacent to the exposed portion 15d, since the sheet member 30 on the positive terminal electrode 13 side and the sheet member 30 on the negative terminal electrode 12 side are separated from each other, short-circuiting between the positive terminal electrode 13 and the negative terminal electrode 12 is curbed via the sheet member 30.

Here, at the overlapping portion P between the first portion 31 and the second portion 32, when the electric power storage module 1 is used, the second portion 32 which is disposed relatively vertically upward overlaps on the first portion 31 which is disposed relatively vertically downward (on the side opposite to the stacked body 10, on the outside). Therefore, water flowing vertically downward is less likely to be stored in the overlapping portion P. Furthermore, in the electric power storage module 1, an insulating tape 45 may be attached to the sheet member 30 to cover the overlapping portion P (to span from the second portion 32 to the first portion 31). Thus, at the overlapping portion P, entrance of water into the inside of the sheet member 30 from between the first portion 31 and the second portion 32 is curbed. Further, the first portion 31 and the second portion 32 are prevented from turning up or peeling off.

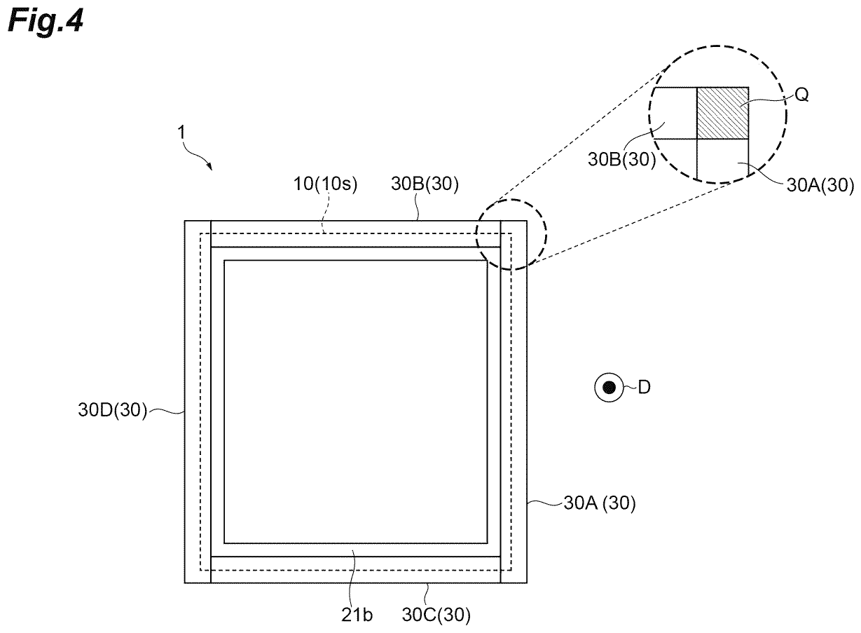

Here, as shown in FIG. 4, the stacked body 10 (the outer surface 10s) has a polygonal shape having a plurality of sides when seen in the stacking direction D. Here, the stacked body 10 has a rectangular shape having four sides when seen in the stacking direction D. The sheet member 30 is formed into a rectangular frame shape when seen in the stacking direction D, and configured of four portions (fourth portions) 30A, 30B, 30C, and 30D along each of the four side portions. In other words, the sheet member 30 is configured of the four portions 30A to 30D that cover each of the four side surfaces of the outer surface 10s having a square tubular shape. That is, the sheet member 30 may be divided into a plurality of fourth portions when seen in the stacking direction D. That is, each of the first portion 31 and the second portion 32 of the sheet member 30 may be divided into the four portions (the fourth portions) 30A, 30B, 30C, and 30D along each of the four side portions when seen in the stacking direction D. When seen in the stacking direction D, in a region including a corner at which two side surfaces of the outer surface 10s intersect, for example, at least parts of the sheet member 30 (for example, the portion 30A and the portion 30B) provided on the two side portions of the stacked body 10 overlap each other to form an overlapping portion Q. That is, end portions of the fourth portions that are adjacent to each other when seen in the stacking direction D may overlap each other to form the overlapping portion Q. Thus, formation of a conductive path due to dew condensation water entering between the portions is curbed.

As described above, in the electric power storage module 1 according to this embodiment, the stacked body 10 includes the plurality of bipolar electrodes 11, the positive terminal electrode 13, and the negative terminal electrode 12. In the stacked body 10, the frame-shaped sealing part 20 for sealing the electrolyte is provided in the space S between the current collectors 15 of each electrode. The sealing part 20 includes a first resin layer 21 provided on each of the current collectors 15 and a second resin layer 22 that seals the space S by welding outer ends of the first resin layer 21 together. The outer surface 10s of the stacked body 10 includes a first surface 21a, a second surface 21b, and an end surface 22s. The first surface 21a and the second surface 21b are outer surfaces in the stacking direction D of the first resin layers 21 provided on the positive terminal electrode 13 and the negative terminal electrode 12, respectively. The end surface 22s is an outer surface of the second resin layer 22. The sheet member 30 including the metal layer 41 is provided to cover the outer surface 10s of the stacked body 10.

Since the metal layer 41 included in the sheet member 30 has high barrier properties against moisture, moisture intrusion into the inside of the stacked body 10 is curbed compared to a case in which the sealing body is formed only with a resin layer. In particular, the sheet member 30 is provided to extend from the first surface 21a to the second surface 21b through the end surface 22s. Therefore, moisture intrusion into the inside of the stacked body 10 can be effectively curbed. Furthermore, since the sheet member 30 is provided in close contact with the stacked body 10, a space is unlikely to be created between the stacked body 10 and the sheet member 30. Therefore, moisture intrusion can be curbed without increasing a size of the electric power storage module 1. In addition, the sheet member 30 is divided on the end surface 22s into the first portion 31 on the positive terminal electrode 13 side and the second portion 32 on the negative terminal electrode 12 side in the cross section along the stacking direction D. The first portion 31 and the second portion 32 are electrically insulated from each other. Therefore, although the outer surfaces of the current collectors 15 of the positive terminal electrode 13 and the negative terminal electrode 12 include the exposed portion 15d exposed to the outside from the sealing part 20, short-circuiting between the positive terminal electrode 13 and the negative terminal electrode 12 is curbed via the sheet member 30. In this way, according to the electric power storage module 1, it is possible to curb moisture intrusion into the inside of the stacked body 10 while a short circuit between the positive terminal electrode 13 and the negative terminal electrode 12 is curbed.

Moreover, in the electric power storage module 1, since the sheet member 30 is divided into the first portion 31 and the second portion 32, when the sheet member 30 is provided in close contact with the stacked body 10, it is only necessary to bring each of the portions into close contact with the stacked body 10 (it is sufficient to stick it thereon), and thus workability is improved. Therefore, when the sheet member 30 is provided, wrinkles are less likely to occur in the metal layer 41 and the like. In addition, in a case in which a (undivided) sheet member containing a metal layer is used, if the sealing part expands and contracts due to heat, as the entire sheet member attempts to deform following the expansion and contraction, the metal layer which is less likely to deform in response to the deformation may break. On the other hand, in the electric power storage module 1, when the sheet member 30 is divided into the first portion 31 and the second portion 32, since the entire sheet member 30 does not deform to follow the expansion and contraction of the sealing part 20 due to heat, breakage of the metal layer 41 is curbed.

Furthermore, in the electric power storage module 1, the first portion 31 and the second portion 32 of the divided sheet member 30 include the overlapping portion P at which they overlap each other. Therefore, the exposed portion of the sealing part 20 from the sheet member 30 is reduced, and the intrusion of not only moisture but also air (nitrogen, oxygen, or the like) is curbed.

Furthermore, in the electric power storage module 1, the sealing part 20 includes a plurality of frame-shaped third resin layers 23. Each of the third resin layers 23 is disposed to be interposed between the first resin layers 21 adjacent to each other in the stacking direction D. The second resin layer 22 seals the space S by welding end portions of the plurality of first resin layers 21 and the plurality of third resin layers 23 on the side opposite to the space S. Therefore, a plurality of spaces S can be sealed all at once by the second resin layer 22 that is integrally formed in the stacking direction D, and manufacturing thereof is easy.

Furthermore, in the electric power storage module 1, the sheet member 30 includes a second insulating layer 43 stacked on the metal layer 41 on the side opposite to the first insulating layer 42. At the overlapping portion P between the first portion 31 and the second portion 32, electrical insulation is formed by overlapping the first insulating layer 42 of the second portion 32 and the second insulating layer 43 of the first portion 31 adjacent to the second portion 32. In this way, since the metal layer 41 is interposed between the two layers of the first insulating layer 42 and the second insulating layer 43, insulation can be easily ensured by overlapping each of the portions of the sheet member 30.

In addition, in the electric power storage module 1, at an overlapping portion P between the first portion 31 and the second portion 32, the second portion 32 located relatively vertically upward overlaps on the first portion 31 located relatively vertically downward. For this reason, at the overlapping portion P, storage of water flowing from vertically upward to vertically downward is curbed.

Furthermore, the electric power storage module 1 may include an insulating tape 45 attached to the sheet member 30 to cover the overlapping portion P between the first portion 31 and the second portion 32. In this case, peeling at the overlapping portion P can be prevented, and moisture intrusion can be reliably curbed.

Furthermore, in the electric power storage module 1, the current collector 15 includes a first region A1, a second region A2, and a third region A3. The first region A1 is a region in which the positive electrode active material layer 16 and the negative electrode active material layer 17 are formed when seen in the stacking direction D. The second region A2 is a region located outside the first region A1 when seen in the stacking direction D. The third region A3 is located outside the second region A2 when seen in the stacking direction D, and is a region in which the first resin layer 21 is formed. The sheet member 30 may extend to the vicinity of a boundary between the third region A3 and the second region A2 when seen in the stacking direction D. In this case, the sheet member 30 is disposed on the first resin layer 21 so that an end portion thereof does not reach the second region A2. By covering a wide region of the sealing part 20 with the sheet member 30, it is possible to more effectively curb moisture intrusion into the inside of the stacked body 10 while short circuit between the positive terminal electrode 13 and the negative terminal electrode 12 is curbed.

Furthermore, in the electric power storage module 1, the stacked body 10 has a rectangular shape having four side portions when seen in the stacking direction D, and the sheet member 30 is configured of the four portions 30A to 30D along each of the four side portions of the stacked body 10 when seen in the stacking direction D. Therefore, the sheet member 30 can be easily constructed by preparing the plurality of portions 30A to 30D corresponding to each of the side portions of the stacked body 10 when seen in the stacking direction D.

In the electric power storage module 1, the sheet member 30 is divided into the plurality of fourth portions (the portions 30A to 30D) when seen in the stacking direction D. When seen in the stacking direction D, the end portions of the adjacent fourth portions overlap each other to form the overlapping portion Q. Therefore, in a configuration in which the sheet member 30 is divided into a plurality of portions when seen in the stacking direction D, formation of a conductive path due to dew condensation water entering between the portions is curbed.

The above embodiment describes one aspect of the electric power storage module according to the present disclosure. The electric power storage module according to the present disclosure may be an arbitrary modification of the electric power storage module 1 described above. Subsequently, modified examples will be described.

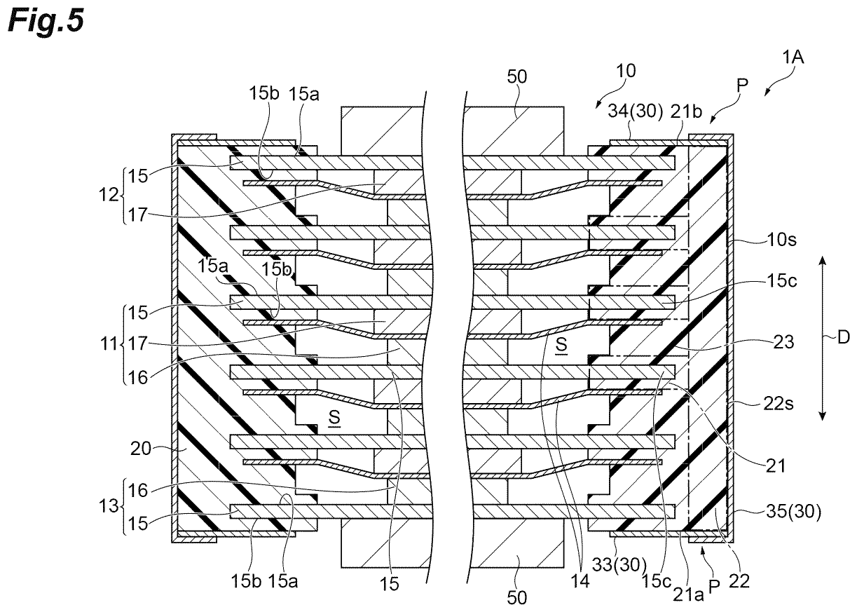

FIG. 5 is a schematic cross-sectional view showing an electric power storage module 1A according to a first modified example. In the electric power storage module 1A shown in FIG. 5, the sheet member 30 is divided into three portions including a first portion 33, a second portion 34, and a third portion 35. The first portion 33 is a portion disposed on the first surface 21a, and the second portion 34 is a portion disposed on the second surface 21b. The first portion 33 and the second portion 34 extend to cover the entire first surface 21a and second surface 21b, respectively.

The third portion 35 covers the end surface 22s and extends from the end surface 22s to overlap each of the first portion 33 and the second portion 34. Then, at an overlapping portion P between each of the first portion 33 and the second portion 34, and the third portion 35, the third portion 35 overlaps on each of the first portion 33 and the second portion 34. That is, at the overlapping portion P between each of the first portion 33 and the second portion 34, and the third portion 35, the third portion 35 overlaps on the outside of the first portion 33 and the second portion 34. More specifically, at the overlapping portion P between the first portion 33 and the third portion 35, in a cross section along the stacking direction D, an end portion of the first portion 33 and an end portion of the third portion 35 are in contact with each other such that the end portion of the first portion 33 is closer to the stacked body 10 than the end portion of the third portion 35 is. Furthermore, at the overlapping portion P between the second portion 34 and the third portion 35, in the cross section along the stacking direction D, an end portion of the second portion 34 and an end portion of the third portion 35 are in contact with each other such that the end portion of the second portion 34 is closer to the stacked body 10 than the end of the third portion 35 is. When seen in the stacking direction D, outer edges of each of the first portion 33 and the second portion 34 only need to be covered by the third portion 35. In the cross section along the stacking direction D, the outer edges of each of the first portion 33 and the second portion 34 are sandwiched between the sealing part 20 and the third portion 35. Although the third portion 35 does not reach a position above the current collector 15 here, it may extend to the position above the current collector 15.

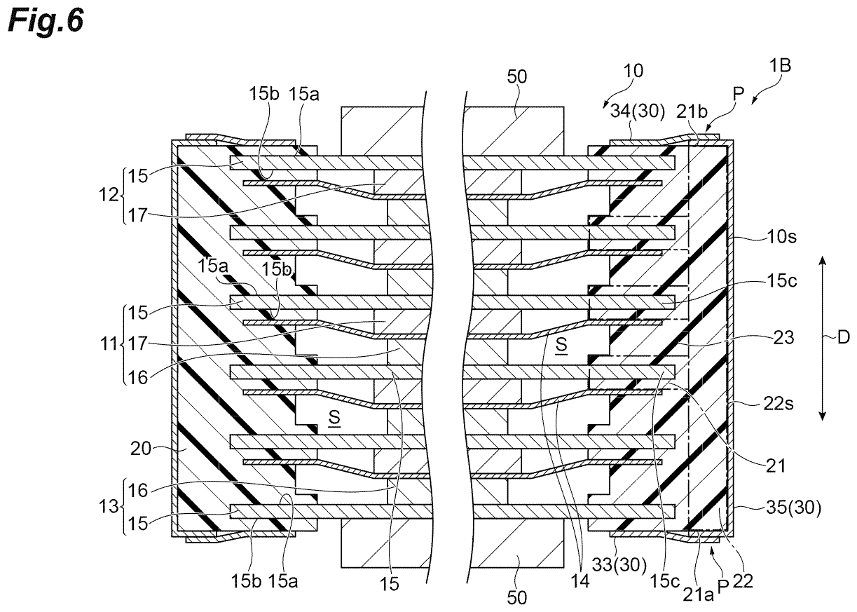

FIG. 6 is a schematic cross-sectional view showing an electric power storage module 1B according to a second modified example. In the electric power storage module 1B shown in FIG. 6, the sheet member 30 is divided into a first portion 33, a second portion 34, and a third portion 35 similar to the electric power storage module 1A. On the other hand, in the electric power storage module 1B, at the overlapping portion P between each of the first portion 33 and the second portion 34, and the third portion 35, the third portion 35 overlaps below each of the first portion 33 and the second portion 34. That is, at the overlapping portion P between each of the first portion 33 and the second portion 34, and the third portion 35, the first portion 33 and the second portion 34 overlap on the outside of the third portion 35. More specifically, at the overlapping portion P between the first portion 33 and the third portion 35, in the cross section along the stacking direction D, the end portion of the first portion 33 and the end portion of the third portion 35 are in contact with each other such that the end portion of the third portion 35 is closer to the stacked body 10 than the end portion of the first portion 33 is. In addition, at the overlapping portion P between the second portion 34 and the third portion 35, in the cross section along the stacking direction D, the end portion of the second portion 34 and the end portion of the third portion 35 are in contact with each other such that the end portion of the third portion 35 is closer to the stacked body 10 than the end portion of the second portion 34 is. When seen in the stacking direction D, the outer edge of the third portion 35 only needs to be covered by each of the first portion 33 and the second portion 34. In the cross section along the stacking direction D, the outer edge of the third portion 35 is sandwiched between each of the first portion 33 and the second portion 34, and the sealing part 20.

Further, although not shown, the sheet member 30 may be divided into a first portion that is disposed on one of the first surface 21a and the second surface 21b and a second portion that extends from the other of the first surface 21a and the second surface 21b via the end surface 22s to overlap the first portion. Then, an insulating tape 45 may be attached to both of the power storage modules 1A and 1B to cover the overlapping portions P.

As described above, various aspects of dividing the sheet member 30 can be considered in order to curb moisture intrusion while short circuits are curbed. Although the example in which the sheet member 30 is divided into two portions and the example in which the sheet member 30 is divided into three portions have been described above, the sheet member 30 may be divided into four or more portions. That is, it is sufficient that adjacent portions of the plurality of portions of the divided sheet member 30 have the overlapping portions P at which they overlap each other.

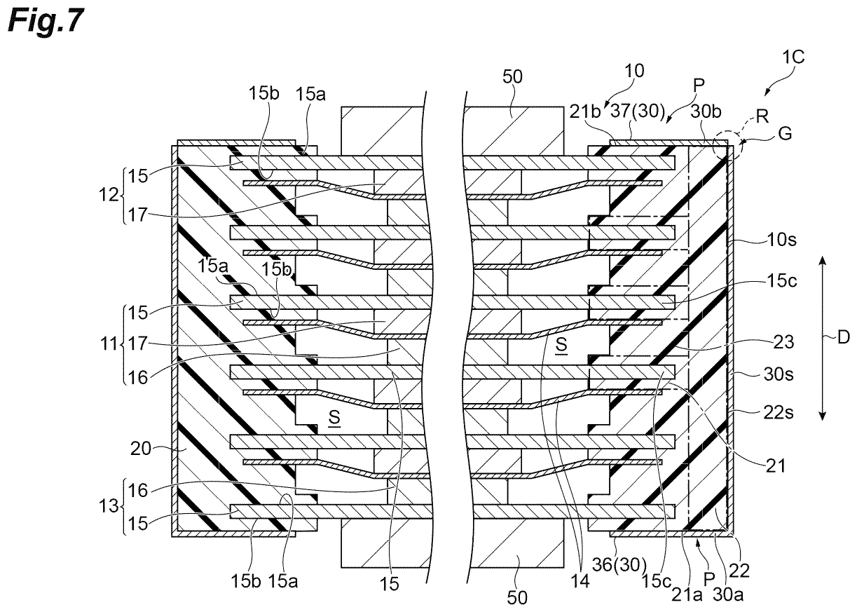

Here, FIG. 7 is a schematic cross-sectional view showing an electric power storage module 1C according to a third modified example. In the above example, although the case in which the divided portions of the sheet member 30 overlap each other has been described, in the example of FIG. 7, although the sheet member 30 is divided into a plurality of portions, the portions do not overlap each other. More specifically, in the electric power storage module 1C shown in FIG. 7, the sheet member 30 includes a first portion 36 that extends from the first surface 21a to cover the end surface 22s, and a second portion 37 that is disposed on the second surface 21b and extends toward the first portion 36. The first portion 36 includes a portion 30a located on the first surface 21a of the sheet member 30 and a portion 30s located on the end surface 22s. The second portion 37 includes (is a portion 30b) a portion 30b located on the second surface 21b. Here, the second portion 37 only needs to be insulated from the first portion 36.

In the example of FIG. 7, an end portion of the first portion 36 on the end surface 22s side is located at a corner portion R of the sealing part 20 that includes the second surface 21b and the end surface 22s. An end portion of the second portion 37 on the end surface 22s side is located at the corner portion R. At the corner portion R, the first portion 36 and the second portion 37 are separated from each other so that a gap G is formed between end portions thereof. Thus, the first portion 36 and the second portion 37 are insulated from each other. An insulating member can be placed in this gap G. In this case, as the insulating member, a liquid insulating resin (for example, liquid silicone) or the like may be provided to fill the gap G. Furthermore, a protective tape such as an insulating tape or a metal laminate film (for example, a film with a layered structure similar to that of the sheet member 30) may be applied to span the first portion 36 and the second portion 37 with the gap G interposed therebetween. As a result, since an end surface of the first portion 36 and an end surface of the second portion 37 with the gap G interposed therebetween are covered with the protective tape, insulation between the first portion 36 and the second portion 37 due to dew condensation or the like is more reliably ensured. The gap G may be set to a minimum length within a range that ensures insulation, but may also be set to a length such that a portion of the outer surface 10s is exposed in consideration of variations in attaching the sheet member 30.

As described above, in the electric power storage module 1C, the first portion 36 and the second portion 37 of the divided sheet member 30 are spaced apart from each other so that a gap G is formed between end portions thereof. Further, an insulating member may be disposed in the gap G. In this way, if the divided portions of the sheet member 30 are spaced apart from each other, breakage of the metal layer 41 due to deformation of the sheet member 30 following the expansion and contraction of the sealing part 20 due to heat is reliably curbed. Furthermore, gas generated inside the sheet member 30 escapes from the gap G, and thus an increase in internal pressure is curbed.

In the example of FIG. 7, a case in which the sheet member 30 is divided into two portions including the first portion 36 and the second portion 37 which are separated from each other has been described. However, the sheet member 30 may be divided into three or more portions spaced apart from each other with a gap G interposed therebetween. Further, even if the sheet member 30 is divided into two portions, a position of the division (that is, a position of the gap G) can be arbitrarily set. For example, the sheet member 30 may be divided into a first portion that extends from the first surface 21a to the middle of the end surface 22s, and a second portion that extends from the second surface 21b to the middle of the end surface 22s, and the gap G may be placed in the middle of the end surface 22s.

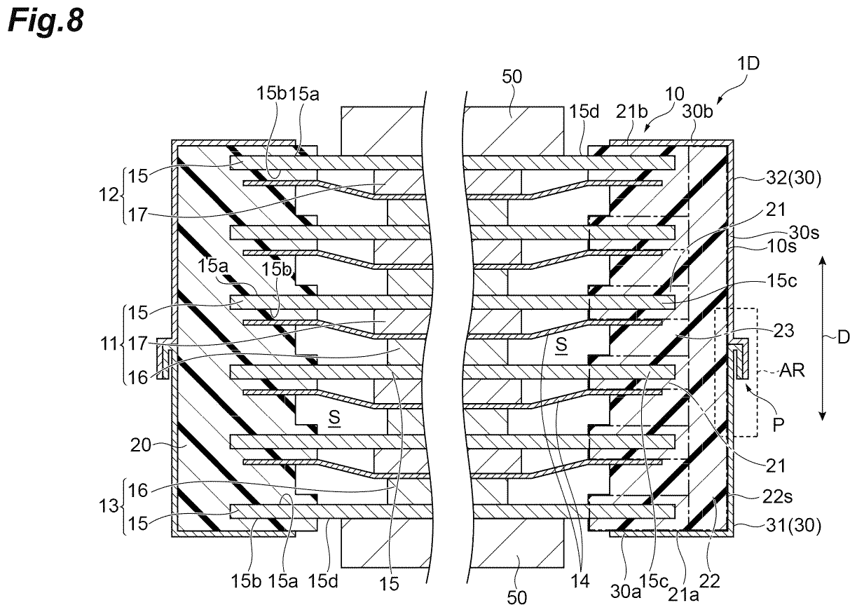

FIG. 8 is a schematic cross-sectional view of an electric power storage module 1D according to a fourth modified example. As shown in FIG. 8, in the electric power storage module 1D, the sheet member 30 is divided into a first portion 31 and a second portion 32, similar to the electric power storage module 1 shown in FIG. 1. On the other hand, in the electric power storage module 1D, the first portion 31 and the second portion 32 are in contact with each other on the end surface 22s. Each of the first portion 31 and the second portion 32 extends to protrude away from the stacked body 10 from a contact portion therebetween. The first portion 31 and the second portion 32 overlap each other at portions protruding from the respective stacked bodies 10 to form an overlapping portion P. At the overlapping portion P, the first portion 31 and the second portion 32 are electrically insulated from each other by bonding (for example, welding) the respective first insulating layers 42 to each other. Thus, at the overlapping portion P, water is prevented from entering the inside of the sheet member 30 from a space between the first portion 31 and the second portion 32.

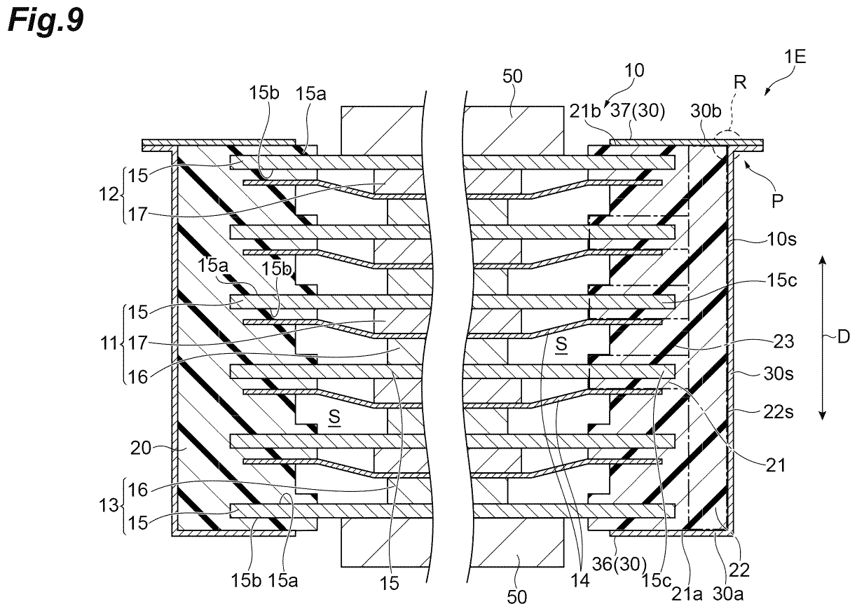

FIG. 9 is a schematic cross-sectional view of an electric power storage module 1E according to a fifth modified example. As shown in FIG. 9, in the electric power storage module 1E, the sheet member 30 is divided into a first portion 36 and a second portion 37, similar to the electric power storage module 1C shown in FIG. 7. On the other hand, in the electric power storage module 1E, the first portion 36 and the second portion 37 are in contact with each other at the corner portion R. Each of the first portion 36 and the second portion 37 extends to protrude away from the stacked body 10 from a contact portion therebetween (that is, the corner portion R). The first portion 36 and the second portion 37 overlap each other at portions protruding from the respective stacked bodies 10 to form an overlapping portion P. At the overlapping portion P, the first portion 36 and the second portion 37 are electrically insulated from each other by bonding (for example, welding) the respective first insulating layers 42 to each other. Thus, at the overlapping portion P, water is prevented from entering the inside of the sheet member 30 from a space between the first portion 36 and the second portion 37. In the electric power storage module 1E, when seen in the stacking direction D, an end portion of the second portion 37 is located outside an end portion (the end surface 22s) of the first surface 21a. In other words, at the overlapping portion P between the first portion 36 and the second portion 37, the end portion of the first portion 36 is located closer to the stacked body 10 than the end portion of the second portion 37.

In the example of FIG. 9, although the first portion 36 and the second portion 37 extend in a direction intersecting the stacking direction D at the overlapping portion P, for example, the first portion 36 and the second portion 37 may be bent inward in the stacking direction D, and thus the first portion 36 and the second portion 37 may extend in the stacking direction D.

Furthermore, in the above example, although the case in which the sheet member 30 has three layers including the first insulating layer 42, the metal layer 41, and the second insulating layer 43 has been described, from the viewpoint of curbing short circuits and moisture intrusion, the sheet member 30 only needs to have at least the metal layer 41 and the first insulating layer 42. Alternatively, the sheet member 30 may have four or more layers including the metal layer 41 and the first insulating layer 42.

Furthermore, in the above example, the sheet member 30 is provided along each of the four side portions of the stacked body 10 when seen in the stacking direction D. However, in the electric power storage modules 1 to 1C, the sheet member 30 only needs to be provided along at least one of the four side portions of the stacked body 10 when seen in the stacking direction D. That is, the sheet member 30 is not limited to the case in which it is configured of four portions 30A to 30D that cover each of the four side surfaces of the square tubular outer surface 10s, and from the viewpoint of curbing short circuits and moisture intrusion, it is sufficient to have a portion that covers at least one side surface.

### REFERENCE SIGNS LIST

1, 1A, 1B, 1C Electric power storage module, 10 Stacked body, 10s Outer surface, 11 Bipolar electrode, 12 Negative terminal electrode, 13 Positive terminal electrode, 15 Current collector, 15c Peripheral edge portion, 15d Exposed portion, 16 Positive electrode active material layer, 17 Negative electrode active material layer, 20 Sealing part, 21 First resin layer, 21a First surface, 21b Second surface, 22 Second resin layer, 22s End surface, 23 Third resin layer, 30 Sheet member, 31, 33, 36 First portion, 32, 34, 37 Second portion, 35 Third portion, 41 Metal layer, 42 First insulating layer, 43 Second insulating layer, 45 Insulating tape, Al First region, A2 Second region, A3 Third region, G Gap, P Overlapping portion

1. An electric power storage module comprising:
a stacked body having an outer surface; and
a sheet member provided in close contact with the stacked body to cover the outer surface in a cross section along a stacking direction of the stacked body,
wherein the sheet member includes a metal layer, and a first insulating layer stacked on the metal layer and disposed closer to the outer surface than the metal layer,
the stacked body includes a plurality of electrodes stacked along the stacking direction, a sealing part, and an electrolyte,
each of the electrodes includes a current collector,
the electrolyte is accommodated in a space between the current collectors adjacent to each other in the stacking direction,
the sealing part is a frame-shaped member configured to seal the electrolyte in the space,
the electrodes include a plurality of bipolar electrodes, a positive terminal electrode, and a negative terminal electrode,
each of the bipolar electrodes includes the current collector, a positive electrode active material layer provided on one surface of the current collector, and a negative electrode active material layer provided on the other surface of the current collector, and is stacked such that the positive electrode active material layer and the negative electrode active material layer face each other,
the positive terminal electrode includes the current collector and the positive electrode active material layer provided on the one surface of the current collector, and is stacked on the bipolar electrode at one end portion in the stacking direction of the stacked body,
the negative terminal electrode includes the current collector and the negative electrode active material layer provided on the other surface of the current collector, and is stacked on the bipolar electrode at the other end portion in the stacking direction of the stacked body,
the sealing part includes a plurality of frame-shaped first resin layers provided on a peripheral edge of each of the plurality of current collectors, and a second resin layer configured to seal the space by welding end portions of each of the plurality of first resin layers on a side opposite to the space,
the outer surface includes an end surface of the second resin layer on the side opposite to the space, a first surface that is an outer surface in the stacking direction of the first resin layer provided on the current collector of the positive terminal electrode, and a second surface that is an outer surface in the stacking direction of the first resin layer provided on the current collector of the negative terminal electrode,
the outer surface of the current collector in the stacking direction in each of the positive terminal electrode and the negative terminal electrode includes an exposed portion exposed to an outside from the sealing part, and
the sheet member extends from the first surface to the second surface via the end surface, and is divided into a plurality of mutually insulated portions in the cross section along the stacking direction.

2. The electric power storage module according to claim 1, wherein adjacent portions of the plurality of portions of the divided sheet member include overlapping portions overlapping each other.

3. The electric power storage module according to claim 1, wherein adjacent portions of the plurality of portions of the divided sheet member are spaced apart from each other such that a gap is formed between the end portions thereof, and
an insulating member is disposed in the gap.

4. The electric power storage module according to claim 1, wherein the sealing part includes a plurality of frame-shaped third resin layers,
the third resin layer is disposed to be interposed between the first resin layers adjacent to each other in the stacking direction, and
the second resin layer seals the space by welding end portions of each of the plurality of first resin layers and the plurality of third resin layers on a side opposite to the space.

5. The electric power storage module according to claim 2, wherein the sheet member includes a second insulating layer stacked on the metal layer on a side opposite to the first insulating layer, and
in the overlapping portion, electrical insulation is formed by overlapping the first insulating layer of one of the portions and the second insulating layer of the other one of the portions adjacent to the one of the portions.

6. The electric power storage module according to claim 2, wherein, in the overlapping portion, one of the portions located relatively vertically upward overlaps on the other one of the portions located relatively vertically downward.

7. The electric power storage module according to claim 2, comprising an insulating tape attached to the sheet member to cover the overlapping portion.

8. The electric power storage module according to claim 2, wherein the plurality of portions includes a first portion which extends from the first surface to the end surface, and a second portion which extends from the second surface to the end surface, and
the first portion and the second portion overlap each other on the end surface.

9. The electric power storage module according to claim 2, wherein the plurality of portions includes a first portion disposed on the first surface, a second portion disposed on the second surface, and a third portion which extends from the end surface to overlap each of the first portion and the second portion, and
at the overlapping portion between each of the first portion and the second portion, and the third portion, the third portion overlaps on an outside of the first portion and the second portion.

10. The electric power storage module according to claim 2, wherein the plurality of portions includes a first portion disposed on the first surface, a second portion disposed on the second surface, and a third portion which extends from the end surface to overlap each of the first portion and the second portion,
at the overlapping portion between the first portion and the third portion, in the cross section along the stacking direction, an end portion of the first portion and an end portion of the third portion are in contact with each other such that the end portion of the third portion is closer to the stacked body than the end portion of the first portion, and
at the overlapping portion of the second portion and the third portion, in the cross section along the stacking direction, an end portion of the second portion and an end portion of the third portion are in contact with each other such that the end portion of the third portion is closer to the stacked body than the end portion of the second portion.

11. The electric power storage module according to claim 1, wherein the plurality of portions includes a first portion which extends from one of the first surface and the second surface to cover the end surface, and a second portion which extends from the other one of the first surface and the second surface toward the first portion.

12. The electric power storage module according to claim 1, wherein the current collector includes a first region in which the positive electrode active material layer and the negative electrode active material layer are formed when seen in the stacking direction, a second region located outside the first region when seen in the stacking direction, and a third region located outside the second region when seen in the stacking direction and in which the first resin layer is formed, and
the sheet member extends to reach near a boundary between the third region and the second region when seen in the stacking direction.

13. The electric power storage module according to claim 1, wherein the stacked body has a rectangular shape having four side portions when seen in the stacking direction, and
the sheet member is provided along at least one of the four side portions when seen in the stacking direction.

14. The electric power storage module according to claim 1, wherein the sheet member is divided into a plurality of fourth portions when seen in the stacking direction, and
when seen in the stacking direction, end portions of the adjacent fourth portions overlap each other to form an overlapping portion.
